(19) United States
(12) Patent Application Publication
(10) Pub. No.: US 2005/0223836 A1
(43) Pub. Date: Oct. 13, 2005

(54) Drive-by-wire assembly with strain gauge

(76) Inventor: Jeffrey G. Gibson, Bellaire, MI (US)

Correspondence Address: BANNER & WITCOFF LTD.,;ATTORNEYS FOR DURA AUTOMOTIVE, 28 STATE STREET - 28TH FLOOR, BOSTON, MA, 02109, US

(21) Appl. No.: 10/814,560

(22) Filed: Mar. 30, 2004

(51) Int. Cl. G06G 7/00

(52) U.S. Cl. 74/478; 701/70

(57) ABSTRACT

A drive-by-wire assembly for a motor vehicle including a pedal configured to undergo no substantial deformation when engaged by a foot of a user. A strain gauge is secured to the pedal and is configured to provide an output signal based on a force applied to the pedal by a foot of a user.

### FIELD OF THE INVENTION

This invention relates generally to a drive-by-wire assembly for a motor vehicle, and, in particular, to a drive-by-wire assembly for a motor vehicle that includes a strain gauge connected to a pedal.

### BACKGROUND OF THE INVENTION

Historically, the pedals for operating a motor vehicle, for example, the accelerator, brake and clutch pedals, have included a mechanical linkage connecting the pedal to the device it is intended to operate. For example, the accelerator pedal may be connected by way of a cable to a throttle assembly, allowing the speed of the vehicle to be varied based on the amount the accelerator pedal is depressed by the user.

Drive-by-wire, e.g., pedal-by-wire, systems have been developed to eliminate the mechanical linkage between the pedal and the target device. These drive-by-wire systems reduce the number of moving parts and the weight of the system, and are intended to increase the accuracy and functionality of the system as well as reduce the service needs of the vehicle. Many known drive-by-wire systems incorporate a sensor that measures the movement of the pedal. This measurement is converted into an electrical signal that is transmitted to the target device such as the throttle, braking assembly or clutch. Although it is not necessary for the pedal to actually move in a drive-by-wire system, vehicle manufacturers often provide a false feedback mechanism that provides resistance to a user to replicate the feel of a standard mechanically linked pedal.

Since such a sensor measures movement of the pedal, any movement, including unintentional movements, will be translated into a change in the output signal. Thus, expansion and contraction of the elements of the mechanical linkage due to temperature changes can affect the accuracy of such a system. Similarly, when a user's foot inadvertently engages the pedal in a non-desired direction, such as from the side or back of the pedal, the output signal can be affected. Consequently, the accuracy of these types of drive-by-wire systems can be affected by unintentional movements of the user's foot.

Additionally, the relatively large amount of movement required with these devices makes for uncomfortable ergonomics. The driver must initially place their foot in an uncomfortable position with the foresight that the moving pedal will eventually be comfortable through the travel range of the pedal. This movement through uncomfortable foot travel ranges can lead to fatigue and discomfort with time.

For safety reasons, drive-by-wire systems often provide a redundant sensor to ensure that a reliable signal is sent to the device to be actuated. This is especially important for braking systems. It is difficult to predict a fail-safe condition for brake systems, since defaulting to a “no braking” or “full braking” condition may or may not be appropriate in a given situation.

It is an object of the present invention to provide a drive-by-wire system with a strain gauge that reduces or overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of certain preferred embodiments.

### SUMMARY

The principles of the invention may be used to advantage to provide a drive-by-wire system for a motor vehicle with a strain gauge connected to a pedal having increased accuracy and reliability.

In accordance with a first aspect, a drive-by-wire assembly for a motor vehicle includes a pedal configured to undergo no substantial deformation when engaged by a foot of a user. A strain gauge is secured to the pedal and is configured to provide an output signal based on a force applied to the pedal by a foot of a user.

In accordance with another aspect, a drive-by-wire assembly for a motor vehicle includes a pedal configured to be engaged by a foot of a user. A strain gauge is secured to the pedal and is configured to provide an output signal based on a force applied to the pedal by a foot of a user. An electronic control unit is connected to the strain gauge and is configured to receive the output signal and output a control signal.

Substantial advantage is achieved by providing a drive-by-wire assembly with a strain gauge connected to a pedal. In particular, the accuracy and reliability of the system controlled by the drive-by-wire assembly can be increased, and its service needs can be decreased, resulting in cost savings. Further, the chance of an output signal being produced from unintentional movement of the pedal is reduced. These and additional features and advantages of the invention disclosed here will be further understood from the following detailed disclosure of certain preferred embodiments.

### BRIEF DESCRIPTION OF THE DRAWINGS

FIG. 1 is a side elevation view of a preferred embodiment of a drive-by-wire assembly in accordance with the present invention.

FIG. 2 is a side elevation view of an alternative embodiment of a drive-by-wire assembly in accordance with the present invention.

FIG. 3 is a side elevation view of another alternative embodiment of a drive-by-wire assembly in accordance with the present invention, shown with a false feedback mechanism.

FIG. 4 is a side elevation view of yet another alternative embodiment of a drive-by-wire assembly in accordance with the present invention, shown with a substantially stationary pedal.

The figures referred to above are not drawn necessarily to scale and should be understood to provide a representation of the invention, illustrative of the principles involved. Some features of the drive-by-wire assembly with a strain gauge depicted in the drawings have been enlarged or distorted relative to others to facilitate explanation and understanding. The same reference numbers are used in the drawings for similar or identical components and features shown in various alternative embodiments. Drive-by-wire assemblies with a strain gauge as disclosed herein would have configurations and components determined, in part, by the intended application and environment in which they are used.

### DETAILED DESCRIPTION OF CERTAIN PREFERRED EMBODIMENTS

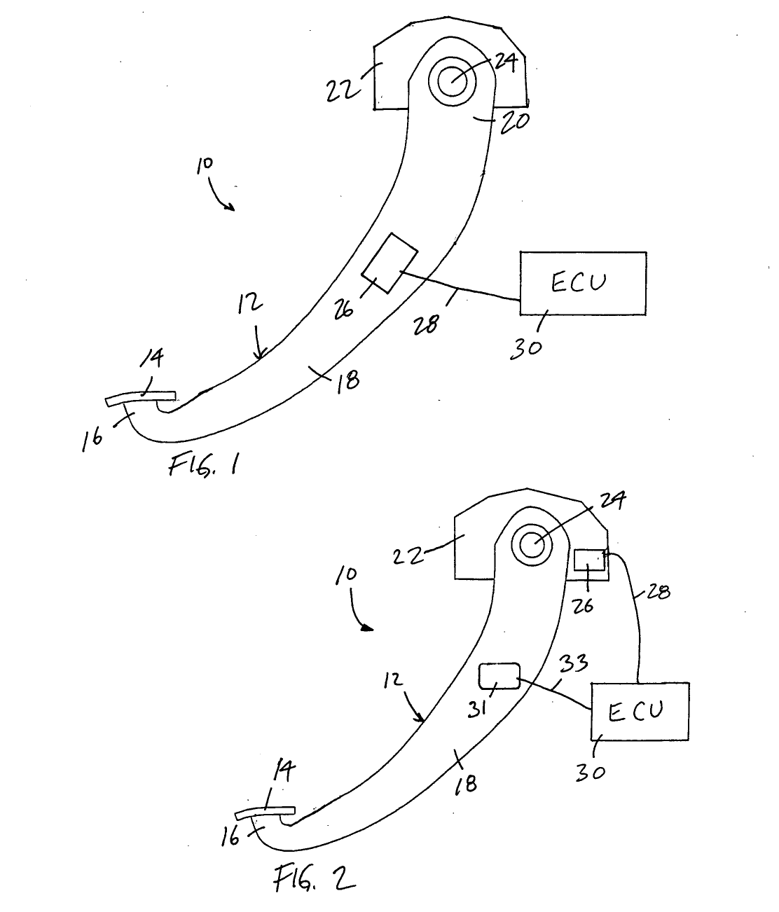

The present invention may be embodied in various forms. A preferred embodiment of a drive-by-wire assembly 10 is shown in FIG. 1. Drive-by-wire assembly 10 includes a foot engaging member such as a pedal 12. Pedal 12 includes a footpad 14 secured to a first end 16 of an arm 18. Footpad 14 is preferably covered with, or has a layer of, rubber or other suitable material to provide friction and a suitable gripping surface for the foot of a user. A second end 20 of arm 18 is preferably pivotally secured to a mounting member such as bracket 22 by way of a pin 24. Bracket 22 is rigidly secured to a front of dash (not shown) of a vehicle by way of suitable fasteners such as bolts (not shown).

A strain gauge 26 is provided on pedal 12 of drive-by-wire assembly 10. Strain gauge 26 measures the force to which strain gauge 26 is exposed when a user's foot is pressed against strain gauge 26. Strain gauge 26 sends an output signal by way of a cable 28 to an electronic control unit (ECU) 36. ECU 30 may contain signal conditioning devices such as an amplifier and noise reduction devices to clean up the signal received from strain gauge 26. ECU 30 may be a part of the target device controlled by drive-by-wire assembly 10, such as a throttle assembly, brake system, or clutch. Alternatively ECU 30 may be an independent unit that in turn sends a control signal to the target device. It is to be appreciated that strain gauge 26 need not be physically connected to ECU 30 by a cable, and that wireless connections are considered to be within the scope of the present invention.

When the user steps on footpad 14 of pedal 12, pedal 12 moves in conventional fashion toward the front of dash of the vehicle. As pedal 12 moves, it retains its shape, and undergoes no substantial deformation. As pedal 12 moves, the force applied by the user's foot is measured by strain gauge 26, which transmits an output signal via cable 28 to ECU 30. ECU 30 then provides a control signal that is then used to control the target device.

In other preferred embodiments, strain gauge 26 can be secured to other portions of drive-by-wire assembly 10. For example, as illustrated in FIG. 2, strain gauge 26 is secured to bracket 22. It is to be appreciated that strain gauge 26 can be secured to any portion of drive-by-wire assembly 10 that is exposed to the force applied by the user's foot. In other words, strain gauge 26 can be placed anywhere along the load path of the force imparted by the user's foot.

In certain preferred embodiments, as illustrated in FIG. 2, drive-by-wire assembly 10 may include an additional sensor 31 secured to pedal 12. As illustrated here, sensor 31 is secured to arm 18 and transmits an output signal by way of a cable 33 to ECU 30. Sensor 31 acts in parallel with the output signal from strain gauge 26 to provide a signal for controlling the target device. Thus, in this embodiment, drive-by-wire assembly 10 has a redundant system providing enhanced reliability. It is to be appreciated that sensor 31 may be a sensor that measures the amount of travel of pedal 12, such as a fiber optic transducer, a potentiometer, or any other sensor suitable for measuring the distance traveled by pedal 12.

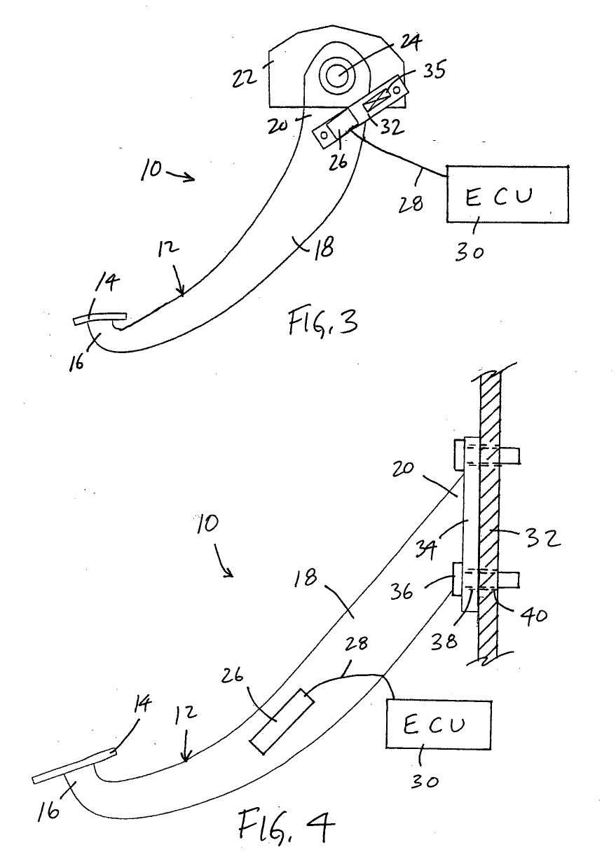

Another preferred embodiment is shown in FIG. 3, in which a false feedback mechanism is provided on drive-by-wire assembly 10. An exemplary false feedback mechanism is an arm 32, having a first end secured to arm 18 and a second end secured to bracket 22. Strain gauge 32 is secured to arm 32. Arm 32 includes a spring 35 that provides resistance to the user when pedal 14 is depressed, simulating the feel of a conventional pedal system with a mechanical linkage. Arm 32 may also include a friction causing element (not shown) that provides additional feedback to the user, simulating the feel of a conventional pedal. One exemplary friction-causing element includes a disk on bracket 22 and a mating disk on arm 18 that slides along the disk on bracket 22 as the arm moves. Suitable friction-causing elements and other types of resistance providing elements will become readily apparent to those skilled in the art, given the benefit of this disclosure. In this embodiment, pedal 12 retains its original shape and undergoes no substantial deformation upon engagement by the foot of a user, as described above.

It is to be appreciated that in certain preferred embodiments, pedal 12 may remain substantially stationary when engaged by the foot of a user. As illustrated in FIG. 4, second end 20 of arm 18 is secured to a front of dash 32 of a vehicle by way of a mounting member such as bracket 34. Bracket 34 is secured to front of dash 32 by way of fasteners such as bolts 36, which extend through apertures 38 in bracket 34 and apertures 40 in front of dash 32.

Unlike a conventional foot pedal in a motor vehicle, which typically has a foot travel of approximately 2-3 inches, pedal 12 remains substantially stationary when engaged by the user's foot and resists any substantial deformation. Due to the force of the user's foot and the laws of physics, the components of pedal 12 of drive-by-wire assembly 10, that is, footpad 14, arm 18, mounting bracket 34 and a portion of front of dash 32, will necessarily move slightly. However, such movement is negligible when compared to the typical 2-3 inch travel of a conventional pedal, and such movement will generally not be identified as significant by the user.

In light of the foregoing disclosure of the invention and description of the preferred embodiments, those skilled in this area of technology will readily understand that various modifications and adaptations can be made without departing from the scope and spirit of the invention. All such modifications and adaptations are intended to be covered by the following claims.

1. A drive-by-wire assembly for a motor vehicle comprising, in combination;
a pedal configured to undergo no substantial deformation when engaged by a foot of a user; and
a strain gauge secured to the pedal and configured to provide an output signal based on a force applied to the pedal by a foot of a user.

2. The drive-by-wire assembly of claim 1, wherein the pedal is an accelerator pedal.

3. The drive-by-wire assembly of claim 1, wherein the pedal is a brake pedal.

4. The drive-by-wire assembly of claim 1, wherein the pedal is a clutch pedal.

5. The drive-by-wire assembly of claim 1, wherein the pedal comprises an arm having a first end and a second end, and a footpad secured to the first end, the second end being secured to a mounting member.

6. The drive-by-wire assembly of claim 5, wherein the mounting member is configured to be secured to a front of dash of a vehicle.

7. The drive-by-wire assembly of claim 6, wherein the strain gauge is secured to the arm of the pedal.

8. The drive-by-wire assembly of claim 6, wherein the strain gauge is secured to the mounting member.

9. The drive-by-wire assembly of claim 6, wherein the second end is pivotally secured to the mounting member.

10. The drive-by-wire assembly of claim 1, further comprising a false feedback member connected to the pedal and configured to provide resistance to foot of a user, the strain gauge being secured to the false feedback member.

11. The drive-by-wire assembly of claim 10, wherein the false feedback member comprises an arm having a first end connected to the pedal and a second end connected to a mounting member to which the pedal is pivotally connected.

12. The drive-by-wire assembly of claim 1, further comprising an electronic control unit configured to receive the output signal from the force measuring sensor.

13. The drive-by-wire assembly of claim 1, wherein the pedal remains substantially stationary when engaged by a foot of a user.

14. The drive-by-wire assembly of claim 1, wherein the pedal moves along a path of travel when engaged by a foot of a user.

15. The drive-by-wire assembly of claim 1, further comprising a sensor configured to send an electrical output signal based on an amount of travel of the pedal, the sensor and the strain gauge configured to operate independently of each other.

16. A drive-by-wire assembly for a motor vehicle comprising, in combination;
a pedal configured to be engaged by a foot of a user;
a strain gauge is secured to the pedal and is configured to provide an output signal based on a force applied to the pedal by a foot of a user; and
an electronic control unit connected to the strain gauge and configured to receive the output signal and output a control signal.

17. The drive-by-wire assembly of claim 16, wherein the pedal is an accelerator pedal.

18. The drive-by-wire assembly of claim 16, wherein the pedal is a brake pedal.

19. The drive-by-wire assembly of claim 16, wherein the pedal is a clutch pedal.

20. The drive-by-wire assembly of claim 16, wherein the pedal remains substantially stationary when engaged by a foot of a user.

21. The drive-by-wire assembly of claim 16, wherein the pedal moves along a path of travel when engaged by a foot of a user.

22. The drive-by-wire assembly of claim 16, further comprising a sensor configured to send an electrical output signal based on an amount of travel of the pedal, the sensor and the strain gauge configured to operate independently of each other.
